(19) United States
(12) Patent Application Publication
(10) Pub. No.: US 2013/0091473 A1
(43) Pub. Date: Apr. 11, 2013

(54) CHANGING DISPLAY BETWEEN GRID AND FORM VIEWS

(71) Applicants: Benjamin E. Rampson, Woodinville, WA (US); Karen X. Cheng, Seattle, WA (US)

(72) Inventors: Benjamin E. Rampson, Woodinville, WA (US); Karen X. Cheng, Seattle, WA (US)

(73) Assignee: MICROSOFT CORPORATION, Redmond, WA (US)

(21) Appl. No.: 13/270,247

(22) Filed: Oct. 11, 2011

(51) Int. Cl. G06F 3/048

(52) U.S. Cl. 715/863

(57) ABSTRACT

Data can be displayed in a display in a first orientation. The display can include a grid view of the data. A user input can be received, where the user input directs a change of orientation of the display from the first orientation to a second orientation. For example, the user input can include rotating a display device. In response to the user input, the orientation of the display can be changed from the first orientation to the second orientation, and the grid view can be changed to a form view of the data. Also, in response to another user input such as rotating the display device, the orientation can be changed from the second orientation to the first orientation, and the display can be changed from the form view to the grid view.

### BACKGROUND

When working on some computing devices such as slate devices or smart phones, display screen space can be limited. This issue can be amplified when the device uses an on-screen soft keyboard which consumes additional screen space, often covering up to half the screen. By the time an application creates space for the additional application features (buttons, menus, scroll bars, etc.), there is frequently very little space available to show document content.

For grid views such as spreadsheets and tables, this issue can be even more noticeable because the data is often organized in a two-dimensional grid, which can be both wide and tall. Accordingly, a grid view may grow in multiple directions (horizontal and vertical), which can result in a user needing to perform many scroll operations to view desired content.

### SUMMARY

The tools and techniques described herein relate to changing a display of data from a grid view to a form view of the data in response to user input. The user input can be input that directs a change of orientation of a display of the data. For example, such input may be provided by rotating a device that includes the display. In response to that input, the display of the data can be changed between a grid view and a form view. As used herein, a grid view is a view where data can extend in multiple directions, such as in a table or a spreadsheet. A form view is a view that is focused on a single record, which is a group of related data from an area in the grid view. For example, the area may be a continuous area such as one row, multiple rows, one column, multiple columns, a block of cells (e.g., a 4 by 15 block of cells), etc.

In one embodiment, the tools and techniques can include displaying data in a display in a first orientation. The display can include a grid view of the data. A user input can be received, where the user input directs a change of orientation of the display from the first orientation to a second orientation. In response to the user input, the orientation of the display can be changed from the first orientation to the second orientation, and the grid view can be changed to a form view of the data.

In another embodiment of the tools and techniques, data can be displayed in a display of a device in a first orientation, where the display includes a form view of the data. A user input can be received, where the first user input includes rotating the device. In response to the user input, the orientation of the display can be changed from the first orientation to a second orientation. Also in response to the user input, the display can be changed from the form view of the data to a grid view of the data.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a data display environment.

FIG. 3 is an illustration of a data display environment showing an implementation of a display with a grid view.

FIG. 4 is an illustration of the data display environment of FIG. 3, showing the display with a form view.

FIG. 5 is a flowchart of a technique for changing a display between grid and form views.

FIG. 6 is a flowchart of another technique for changing a display between grid and form views.

FIG. 7 is a flowchart of yet another technique for changing a display between grid and form views.

### DETAILED DESCRIPTION

Embodiments described herein are directed to techniques and tools for changing a display of data from grid view to form view and/or from form view to grid view. Such improvements may result from the use of various techniques and tools separately or in combination.

Such techniques and tools may include responding to user input directing a change in orientation of a display (e.g., by rotating a device) by automatically changing a display of data from a grid view of the data, such as a spreadsheet or table, to a form view of the data. For example, changing the device from a landscape orientation (which shows the grid view) to a portrait orientation could result in this form view being automatically shown.

One or more substantial benefits may be realized from the tools and techniques described herein. For example, the form view may provide users with an easy way to dive into and view/edit the details of the data. Also, providing an indication to change orientation of the display (e.g., by rotating a display device) may be an intuitive way to provide user input to also direct a change between a grid and form view of data.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware implementations, such as application specific integrated circuits, programmable logic arrays and other hardware devices, can be constructed to implement at least a portion of one or more of the techniques described herein. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

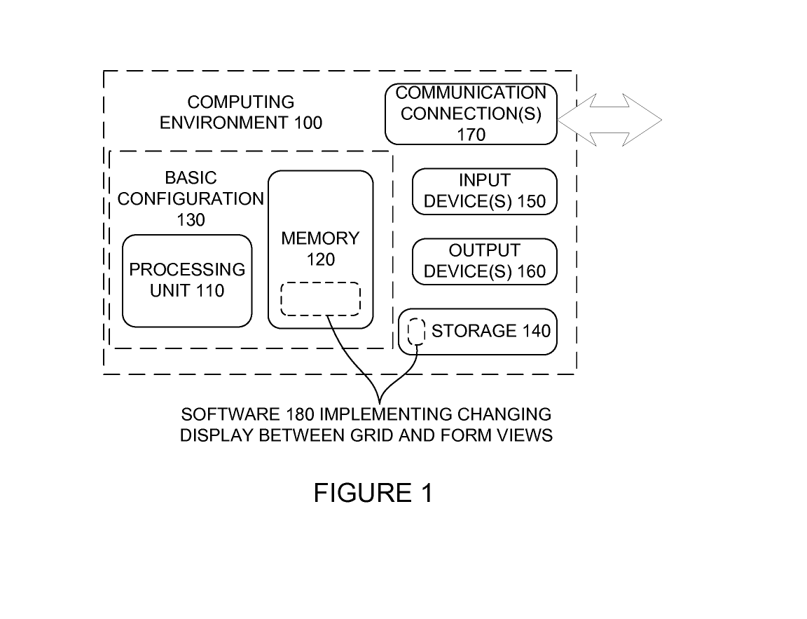

FIG. 1 illustrates a generalized example of a suitable computing environment (100) in which one or more of the described embodiments may be implemented. For example, one or more such computing environments can be used as a device for changing between a grid view and a form view. Generally, various different general purpose or special purpose computing system configurations can be used. Examples of well-known computing system configurations that may be suitable for use with the tools and techniques described herein include, but are not limited to, server farms and server clusters, personal computers, server computers, hand-held devices (e.g., slate devices, smart phones, etc.), laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing changing a display between a grid and a form view.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “change,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. System and Environment for Changing Display Between Grid and Form Views

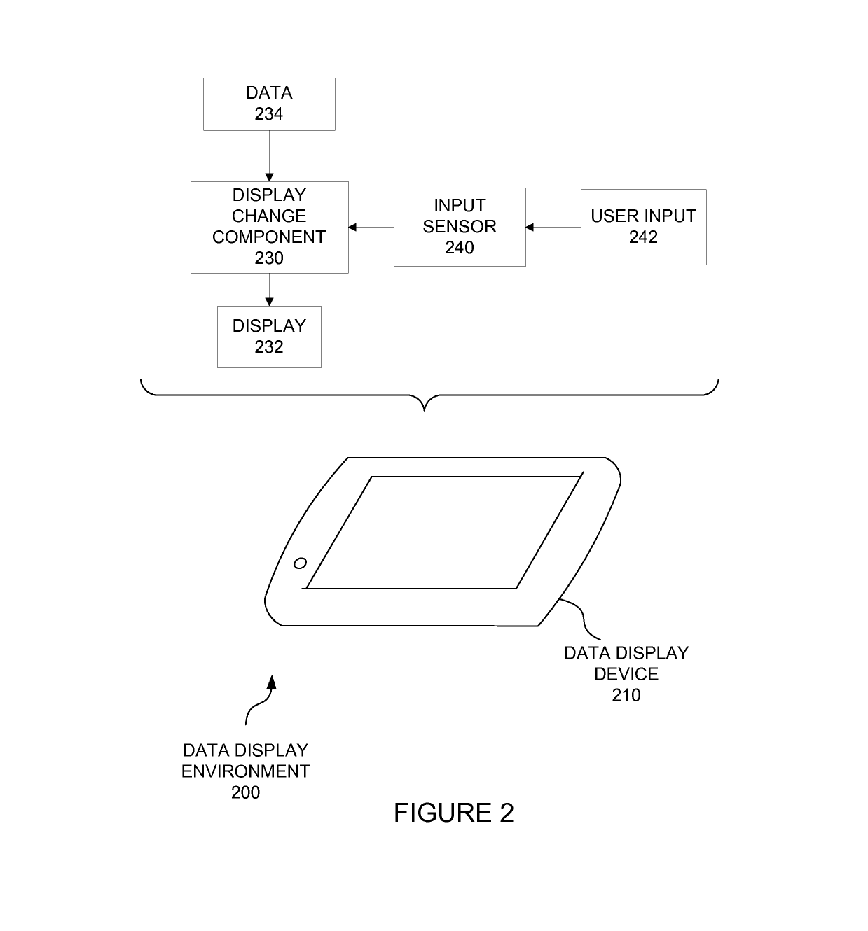

FIG. 2 is a block diagram of a data display environment (200) in conjunction with which one or more of the described embodiments may be implemented. The environment (200) can include a data display device (210). For example, the data display device may be a handheld device such as a slate device, a smart phone, etc. The data display device (210) can include a display change component (230), which can access data (234) and change the way that the data (234) is displayed on the data display device (210). For example, the display change component (230) can include a rendering engine as well as executable instructions for changing orientations and changing between a form view of data and a grid view of data. An input sensor (240) can sense user input (242) from a user that indicates a change in orientation of the display (232). For example, the input sensor (240) may be a sensor for a keyboard key or a mouse key, a touch pad, or an orientation sensor. If the input sensor (240) is an orientation sensor, the user input can be provided by rotating the display device (210) from a first orientation to a second orientation. This change in orientation can be sensed by the input sensor (240), and the input sensor (240) can emit a resulting user input signal, which can be provided to the display change component (230), possibly after undergoing processing by other components of the display device (210). In response to this user input (242), the display change component (230) can change the orientation of the display (232). The display change component (230) can also change the display (232) from a grid view of data to a form view of data, or from a form view of data to a grid view of data. For example, this change to the display (232) can be done using techniques for building or modifying a user interface representation that includes user interface elements.

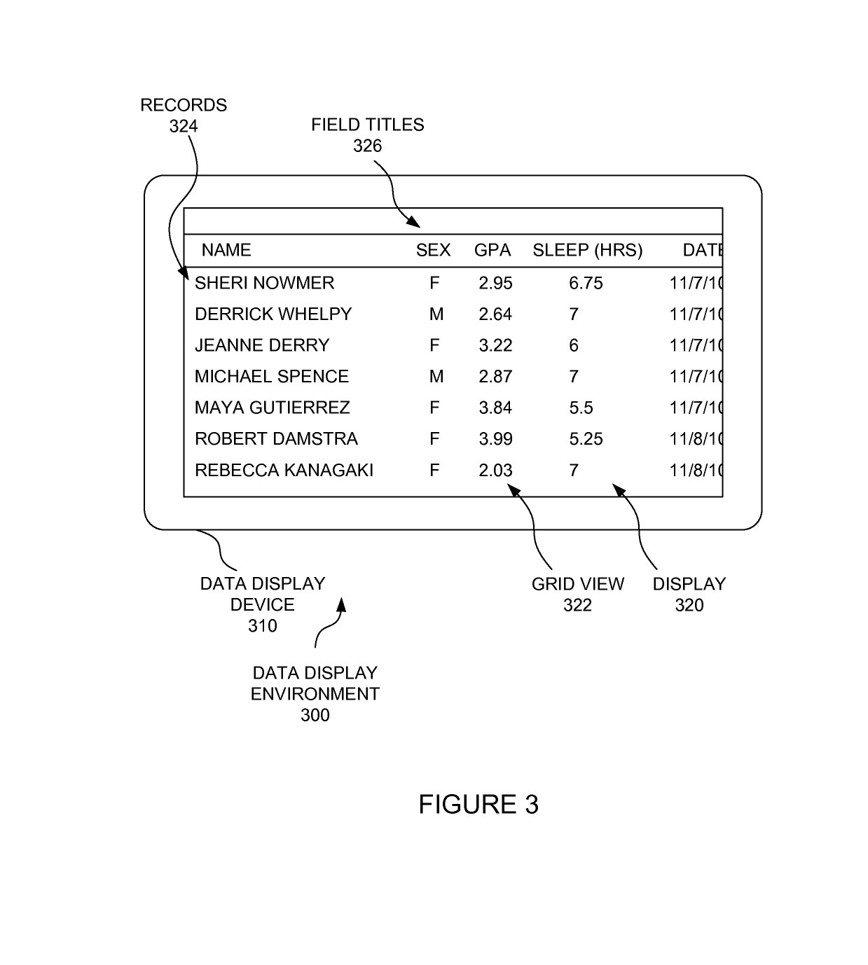

Referring now to FIG. 3, an example of a data display environment (300) will be discussed. The data display environment (300) can include a data display device (310), such as one of the types of devices discussed above. As illustrated in FIG. 3, the data display device is in a landscape orientation. A display (320) on the data display device (310) can display a grid view (322) of data. The grid view (322) can include rows of records (324) with field titles (326) forming a top row of the grid view (322), with the field titles (326) being positioned as column headers. Alternatively, the grid view (322) could be formatted in some other manner, such as with columns and rows being transposed from what is illustrated in FIG. 3.

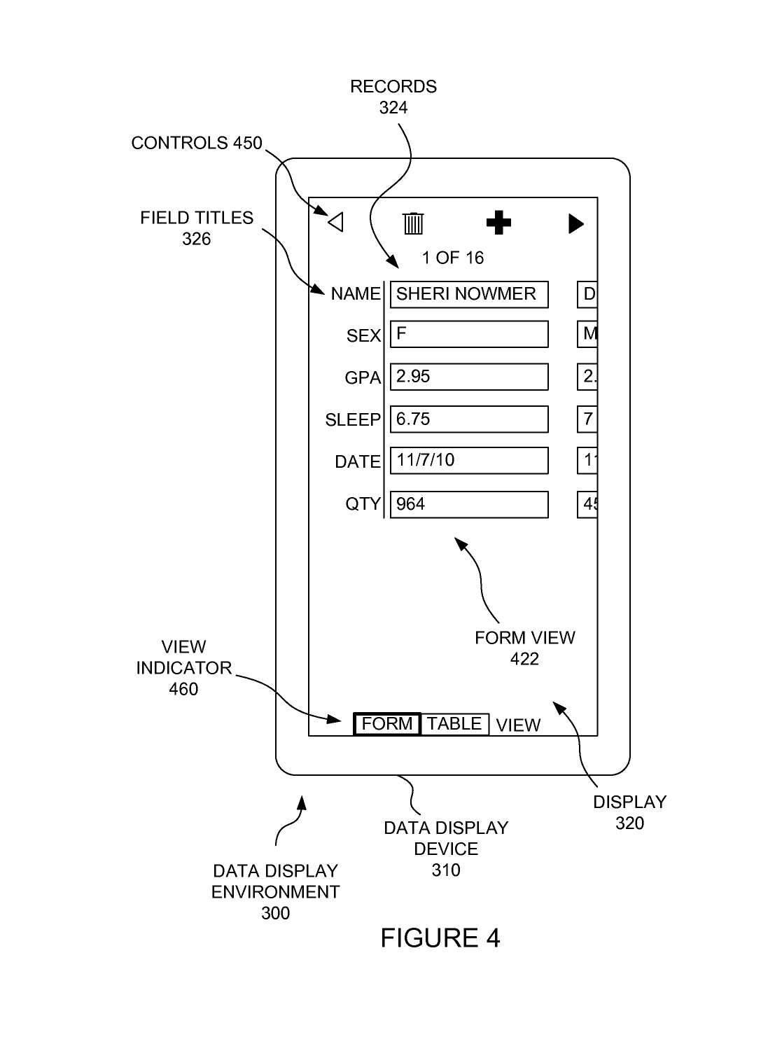

User input may be provided to the data display device (310) to indicate a change in the orientation of the display (320). For example, such user input may be provided by a user rotating the data display device (310) from the landscape orientation of FIG. 3 to a portrait orientation of FIG. 4. Referring to FIG. 4, in response to the user input, the data display device (310) can change the display (320) from the grid view (322) to a form view (422) illustrated in FIG. 4. The form view (422) includes a display of a record (324) upon which the form view (422) is focused (in the illustration of FIG. 4, the record for “Sheri Nowmer,” which was in a row in FIG. 3). The form view (422) can include data and field titles (326) that were displayed in the grid view (322), and the form view (422) may also display additional data that did not fit on the display (320) in the grid view (322). While the form view (422) is focused on a single record, a portion of an additional record may also be shown to communicate to a user that the display (320) can be scrolled to focus on that record. For example, user input for scrolling may be provided by selecting an arrow button in the controls (450), or by dragging the currently-displayed record to focus on a new record. The display may also include a view indicator (460), which can indicate that the form view (422) is currently being displayed. Such an indicator, as well as controls, may also be displayed in the grid view, although an indicator and controls are not shown in the implementation illustrated in FIG. 3.

The form view (422) may be able to display all the data for a record that is the focus of the display. However, if all the data will not fit on the display (320), controls may be provided to scroll to additional data that is not currently displayed.

While the implementation of FIGS. 3-4 above has been discussed as an example, changes may be made. For example, the grid view may be displayed in a portrait orientation, while the form view may be displayed in a landscape orientation. As another example, each record in the form view may be displayed in different ways, such as in multiple columns.

### III. Techniques for Changing Display Between Grid and Form Views

Several techniques for changing display between grid and form views will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique.

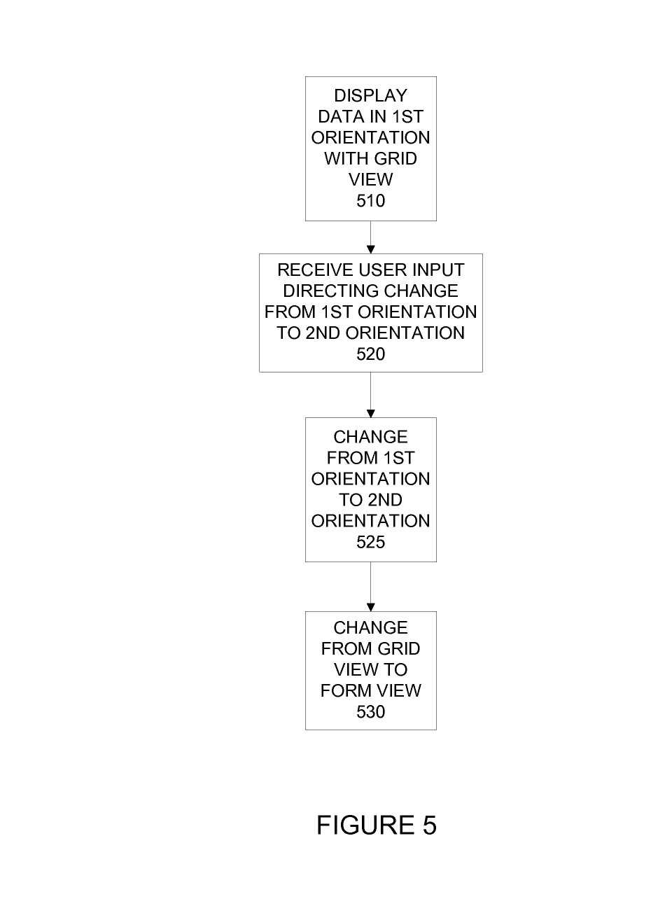

Referring to FIG. 5, a technique for changing a display between grid and form views will be described. The technique can include displaying (510) data in a display in a first orientation. The display can include a grid view of the data. User input can be received (520), where the user input can direct a change of orientation of the display from the first orientation to a second orientation. In response to the user input, the orientation of the display can be changed (525) from the first orientation to the second orientation. Also, in response to user input directing the change of orientation from the first orientation to the second orientation, the grid view can be changed (530) from the grid view to a form view of the data.

Changing the display of the data from the grid view to the form view can include transposing directions of the display of the data. For example, transposing may include transposing rows and columns of the data. For example, a data record that was displayed as a row in the grid view can be displayed as one or more columns in the form view.

The form view of the data can focus on a single record of one or more records of the data at a time. Also, each of the one or more records can include one or more columns of data from the grid view. Each of the one or more records can include one or more rows of data from the grid view. The form view may also include one or more field titles for the data. For example, the one or more field titles can be from one or more headers in the grid view (i.e., the field title(s) can be the same as, derived from, or derived from the same source as field titles that are used as header(s) in the grid view).

The technique may also include receiving a user input directing a change of orientation of the display from the second orientation to the first orientation. In response to the user input directing the change of orientation from the second orientation to the first orientation, the orientation of the display can be changed from the second orientation back to the first orientation. Also in response to the user input directing the change of orientation from the second orientation to the first orientation, the form view can be changed back to the grid view.

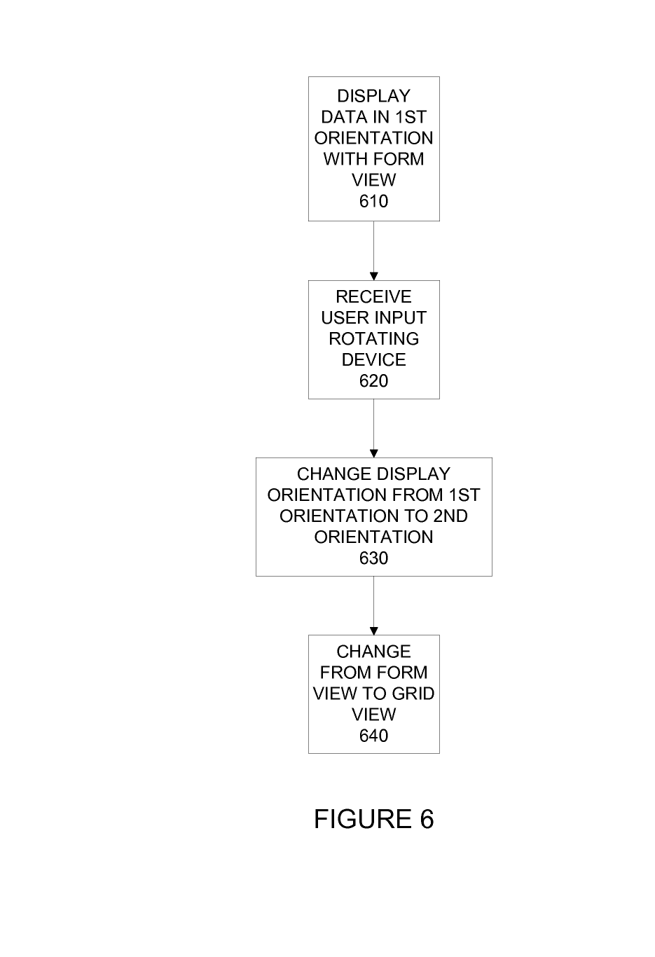

Referring to FIG. 6, another technique for changing a display between grid and form views will be described. The technique can include displaying (610) data in a display of a device in a first orientation. The display can include a form view of the data. User input can be received (620), where the user input includes rotating the device. In response to the user input, the orientation of the display can be changed (630) from the first orientation to a second orientation. Also in response to the user input, the form view can be changed (640) to a grid view of the data.

Changing (630) the display of the data from the form view to the grid view can include transposing directions of the display of the data. The form view may include one or more columns, and the form view can focus on a single record of one or more records of the data at a time. Each of the one or more records can include one or more rows of data from the grid view or one or more columns of data from the grid view. The form view can include one or more field titles for the data. The field title(s) can be from one or more headers from the grid view.

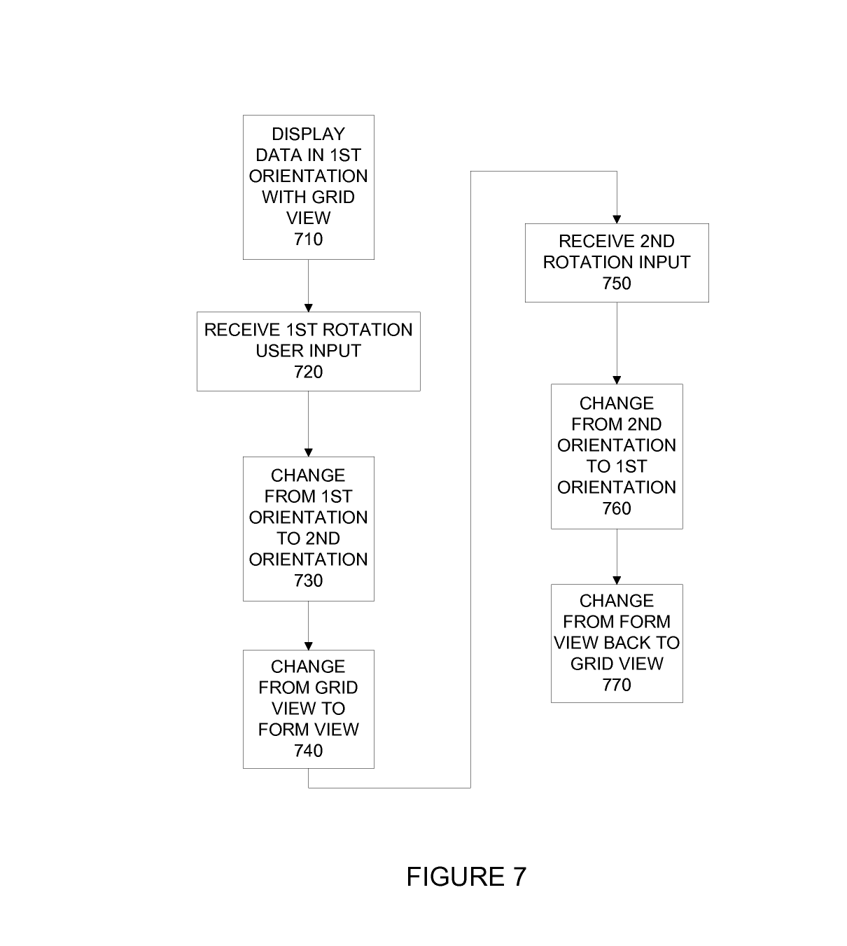

Referring to FIG. 7, yet another technique for changing a display between grid and form views will be described. The technique can include displaying (710) data in a display of a device in a first orientation. The display may include a grid view of the data. A first user input that includes rotating the device can be received (720). In response to the first user input, the orientation of the display can be changed (730) from the first orientation to a second orientation. In response to the first user input, the display can be changed (740) from the grid view to a form view of the data. The form view of the data can focus on a single record of the one or more records of the data at a time. Each of the record(s) can include an area of data from the grid view, and the form view can also include one or more field titles for the data. The area of the data can include one or more rows of data from the grid view or one or more columns of data from the grid view.

The technique of FIG. 7 may also include receiving (750) a second user input that includes rotating the device. In response to the second user input, the orientation of the display can be changed (760) from the second orientation to the first orientation. Also in response to the second user input, the display can be changed (770) from the form view back to the grid view.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method, comprising:
displaying data in a display in a first orientation, the display comprising a grid view of the data;
receiving a user input directing a change of orientation of the display from the first orientation to a second orientation;
in response to the user input directing the change of orientation from the first orientation to the second orientation, changing the orientation of the display from the first orientation to the second orientation; and
in response to the user input directing the change of orientation from the first orientation to the second orientation, changing from the grid view to a form view of the data.

2. The method of claim 1, further comprising:
receiving a user input directing a change of orientation of the display from the second orientation to the first orientation;
in response to the user input directing the change of orientation from the second orientation to the first orientation, changing the orientation of the display from the second orientation to the first orientation; and
in response to the user input directing the change of orientation from the second orientation to the first orientation, changing from the form view of the data back to the grid view of the data.

3. The method of claim 1, wherein changing the display of the data from the grid view to the form view comprises transposing directions of the display of the data.

4. The method of claim 1, wherein the user input directing the change of orientation comprises rotating a device that includes the display.

5. The method of claim 1, wherein the form view of the data comprises one or more columns.

6. The method of claim 1, wherein the form view of the data focuses on a single record of one or more records of the data at a time.

7. The method of claim 6, wherein each of the one or more records comprises one or more columns of data from the grid view.

8. The method of claim 6, wherein each of the one or more records comprises one or more rows of data from the grid view.

9. The method of claim 1, wherein the form view comprises one or more field titles for the data.

10. The method of claim 9, wherein the one or more field titles are from one or more headers in the grid view.

11. A computer system comprising at least one processor and memory comprising instructions stored thereon that when executed by at least one processor cause at least one processor to perform acts comprising:
displaying data in a display of a device in a first orientation, the display comprising a form view of the data;
receiving a user input comprising rotating the device;
in response to the user input, changing the orientation of the display from the first orientation to a second orientation; and
in response to the user input, changing from the form view to a grid view of the data.

12. The computer system of claim 11, wherein changing the display of the data from the form view to the grid view comprises transposing directions of the display of the data.

13. The computer system of claim 11, wherein the form view of the data comprises one or more columns.

14. The computer system of claim 11, wherein the form view of the data focuses on a single record of one or more records of the data at a time.

15. The computer system of claim 14, wherein each of the one or more records comprises one or more rows of data from the grid view.

16. The computer system of claim 14, wherein each of the one or more records comprises one or more columns of data from the grid view.

17. The computer system of claim 11, wherein the form view comprises one or more field titles for the data, the one or more field titles being from one or more headers from the grid view.

18. One or more computer-readable storage media having computer-executable instructions embodied thereon that, when executed by at least one processor, cause at least one processor to perform acts comprising:
displaying data in a display of a device in a first orientation, the display comprising a grid view of the data;
receiving a first user input comprising rotating the device;
in response to the first user input, changing the orientation of the display from the first orientation to a second orientation; and
in response to the first user input, changing the display from the grid view to a form view of the data, the form view of the data focusing on a single record of one or more records of the data at a time, each of the one or more records comprising an area of data from the grid view, and the form view also comprising one or more field titles for the data;
receiving a second user input comprising rotating the device;
in response to the second user input, changing the orientation of the display from the second orientation to the first orientation; and
in response to the second user input, changing the display from the form view of the data back to the grid view of the data.

19. The one or more computer-readable storage media of claim 18, wherein the area of data comprises one or more rows of data from the grid view.

20. The one or more computer-readable storage media of claim 18, wherein the area of data comprises one or more columns of data from the grid view.
